(19) United States
(12) Patent Application Publication
(10) Pub. No.: US 2018/0001456 A1
(43) Pub. Date: Jan. 4, 2018

(54) CORDLESS CONCRETE NAILER WITH IMPROVED POWER TAKE-OFF MECHANISM

(71) Applicant: Black & Decker Inc., New Britain, CT (US)

(72) Inventor: Stuart E. GARBER, Towson, MD (US)

(73) Assignee: Black & Decker Inc., New Britain, CT (US)

(21) Appl. No.: 15/630,273

(22) Filed: Jun. 22, 2017

Related U.S. Application Data
(60) Provisional application No. 62/357,515, filed on Jul. 1, 2016.
(60) Provisional application No. 62/356,966, filed on Jun. 30, 2016.

(51) Int. Cl. B25C 1/06; B25C 1/00

(52) U.S. Cl. CPC B25C 1/06; B25C 1/008

(57) ABSTRACT

A power take-off (PTO) assembly of a cordless electric concrete driver includes a bracket supporting a solenoid and a compression spring and a linkage arm coupled between a plunger of the solenoid and the compression spring. The linkage arm is biased by the compression spring toward the nail driver. A carrier supports or carries a pinch roller and the carrier is pivotably mounted to the bracket via a pivot pin. An engaging surface is movable with the plunger between an engagement position in which the engaging surface engages a cooperating engaging surface of the carrier and orients the carrier into a corresponding engagement orientation, and a disengagement position in which the engaging surface is spaced away from the cooperating engaging surface of the carrier, allowing the carrier to pivot outside the corresponding engagement orientation.

### CROSS-REFERENCE TO RELATED APPLICATIONS

This application claims the benefit of U.S. Provisional Application No. 62/356,966, filed on Jun. 30, 2016. This application also claims the benefit of U.S. Provisional Application No. 62/357,515, filed on Jul. 1, 2016. The entirety of each of the above applications is incorporated herein by reference.

### FIELD

The present disclosure relates to power nailers and in particular to a cordless concrete nailer having an improved power take-off mechanism that increases the transfer of energy from the flywheel to the driver.

### BACKGROUND

This section provides background information related to the present disclosure which is not necessarily prior art.

Fastening tools, such as power nailers have become relatively common place in the construction industry. While power nailers were initially predominantly pneumatic powered, cordless electric powered nailers have become increasingly popular due to the lack of hoses and the need for a source of pneumatic power. However, pneumatic powered nailers and power actuated nailers continue to predominate for those construction applications, such as steel framing and concrete construction, which employ fasteners requiring a high degree of power to install the fasteners. Hence, while cordless electric powered nailers have become very successful for use in conventional wood framing construction, power nailers of this type are presently not capable of reliably installing concrete fasteners, including the installation of hardened fasteners through steel framing into concrete; particularly for use in commercial construction applications.

For example, commonly assigned U.S. Pat. No. 9,399,281, filed Mar. 12, 2013 and issued Jul. 26, 2016 discloses a power take-off (PTO) assembly of a cordless electric powered nailer including a carrier pivotably supporting a pinch roller. A pair of torsion springs (identified in the patent by reference number 3060) operate to position the carrier in an initial angular or pivotable orientation. This avoids the carrier being in an improper orientation upon activation that results in the tool misfiring. A rotational or pivot force is imparted to the carrier that has a magnitude that is related to a magnitude of the pinch force on the driver. Because these magnitudes are relatively small in conventional wood framing construction, the torsion springs are typically capable of surviving being repeatedly subjected to such forces throughout the life of the tool. Such torsional springs, however, have not been found to provide similar survivability in the context of the forces involved in a concrete fastener installation tool or driver; particularly in a commercial construction context.

### SUMMARY

This section provides a general summary of the disclosure, and is not a comprehensive disclosure of its full scope or all of its features. In addition, any feature or combination of features included in this general summary are not necessarily critical or particularly important to the disclosure.

In accordance with one aspect of the disclosure, a cordless electric nailer includes a power take-off (PTO) assembly positioned to selectively engage a nail driver against a flywheel. The PTO includes a bracket supporting a solenoid and a compression spring and a linkage arm coupled between a plunger of the solenoid and the compression spring. The linkage arm is biased by the compression spring toward the nail driver. A carrier supports or carries a pinch roller and the carrier is pivotably mounted to the bracket via a pivot pin. An engaging surface is movable with the plunger between an engagement position in which the engaging surface engages a cooperating engaging surface of the carrier and orients the carrier into a corresponding engagement orientation, and a disengagement position in which the engaging surface is spaced away from the cooperating engaging surface of the carrier, allowing the carrier to pivot outside the corresponding engagement orientation.

In accordance with another aspect of the disclosure, a cordless electric concrete nailer includes a power take-off (PTO) assembly positioned to selectively engage a concrete nail driver against a flywheel. The PTO includes a bracket supporting a solenoid and a compression spring and a linkage arm coupled between a plunger of the solenoid and the compression spring. The linkage arm is biased by the compression spring toward the concrete nail driver. A carrier supports or carries a pinch roller and the carrier is pivotably mounted to the bracket via a pivot pin. An engaging surface is movable with the plunger between an engagement position in which the engaging surface engages a cooperating engaging surface of the carrier and orients the carrier into a corresponding engagement orientation, and a disengagement position in which the engaging surface is spaced away from the cooperating engaging surface of the carrier, allowing the carrier to pivot outside the corresponding engagement orientation. The spring of the concrete nailer provides a biasing force on the linkage arm that generates a compressive force of at least about 500 pounds per square inch on the concrete nail driver through the pinch roller.

Further areas of applicability will become apparent from the description provided herein. It should be understood that the description and specific examples in this summary are intended for purposes of illustration only and are not intended to limit the scope of the present disclosure, its application and/or uses in any way.

### BRIEF DESCRIPTION OF THE DRAWINGS

The drawings described herein are for illustration purposes only and are not intended to limit the scope of the present disclosure in any way.

FIG. 1 is a perspective view of an exemplary nailer constructed in accordance with the teachings of the present disclosure;

FIG. 2 is a perspective view of a portion of the nailer of FIG. 1;

FIG. 3 is a perspective view of a portion of the nailer of FIG. 1, illustrating a drive motor assembly in more detail;

FIG. 4 is a sectional view of the portion of the nailer shown in FIG. 3, taken along line 4-4;

FIG. 5 is a block diagram of the control circuit for the nailer;

FIGS. 6A-6D are detailed sectional views of the power take-off assembly of the nailer; and

FIG. 7 is a perspective view of the release lever for the power take-off assembly.

Corresponding reference numerals indicate corresponding parts throughout the several views of the drawings.

### DETAILED DESCRIPTION OF THE PREFERRED EMBODIMENTS

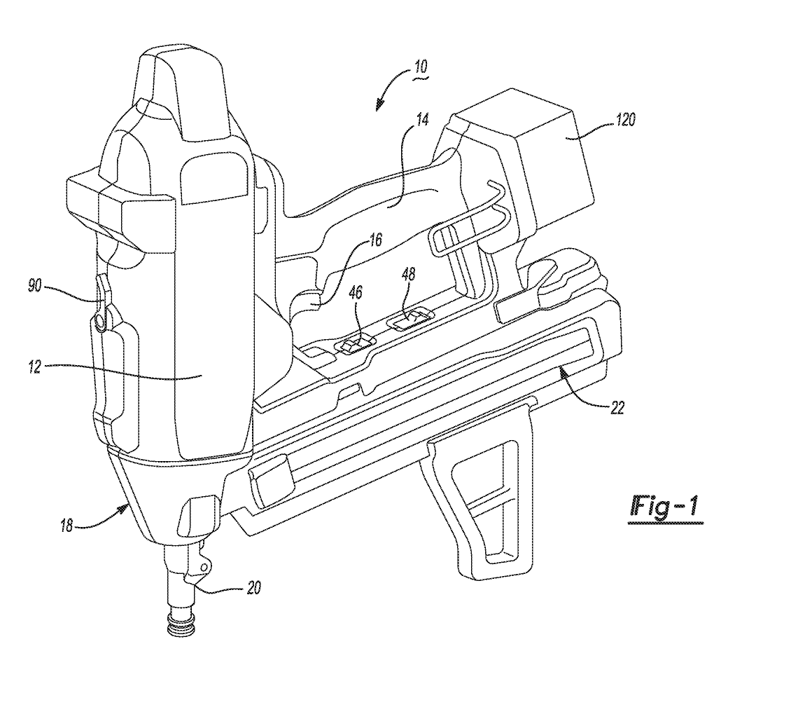

With reference to FIG. 1, a cordless concrete nailer in accordance with the teachings of the present disclosure is shown and generally indicated by reference numeral 10. The nailer 10 includes a housing 12 having a handle portion 14 containing a trigger switch 16. Connected to the lower end of the housing 12 is a nosepiece assembly 18 having a contact trip mechanism 20 projecting therefrom. Also coupled to the nosepiece assembly 18 and oriented substantially parallel to the handle 14 of the housing 12 is a magazine assembly 22 which is configured to hold a plurality of fasteners and sequentially dispense the fasteners into the nosepiece assembly 18. The details of the magazine assembly are conventional and will not be discussed in further detail.

Preferably, a battery pack 120 is removably coupled to the base of the handle portion 14 of the housing 12. The battery pack 120 may comprise a 24 volt lithium-ion based power cell which is capable of supplying the power required to properly install an appropriate number of hardened steel nails through steel framing into concrete on a single full charge.

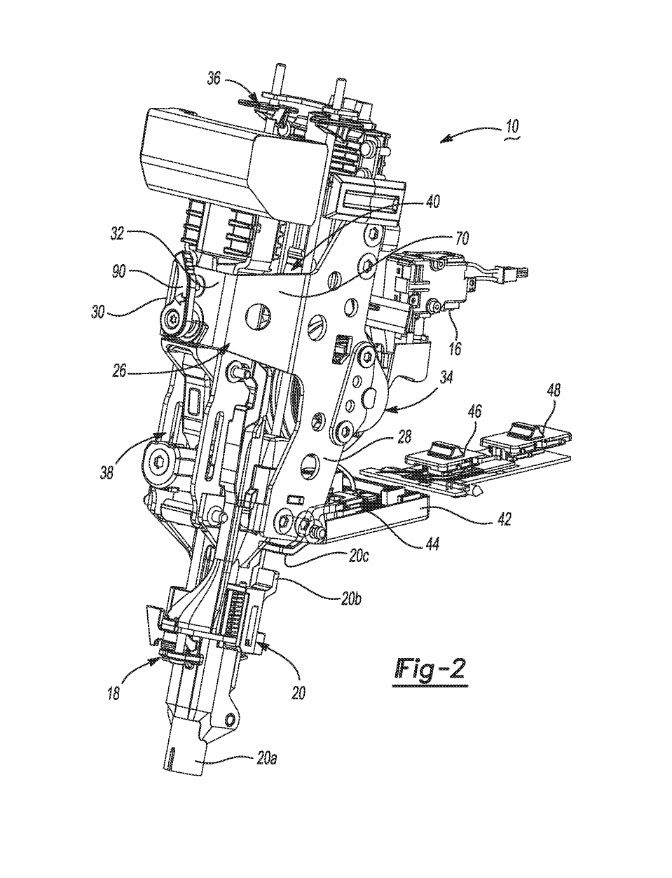

Referring to FIG. 2, a perspective view of a portion of the present cordless concrete nailer 10 is shown with the outer housing removed. The cordless concrete nailer 10 includes a frame or backbone member 26 having first and second, spaced-apart, generally parallel arm segments 28, 30 that are integrally joined to a generally U-shaped central bridge segment 32. The frame member 26 is preferably made from high strength stamped steel. Mounted to the frame member 26 between the arm segments 28, 30 of the frame are the motor/flywheel assembly 34, the driver assembly 36, the power take-off assembly 38 and a driver retraction assembly 40. Also mounted to the lower end of the frame 26 are the nosepiece assembly 18 and an electronic control module 42 containing a microcontroller-based control circuit 100 for controlling the operation of the tool.

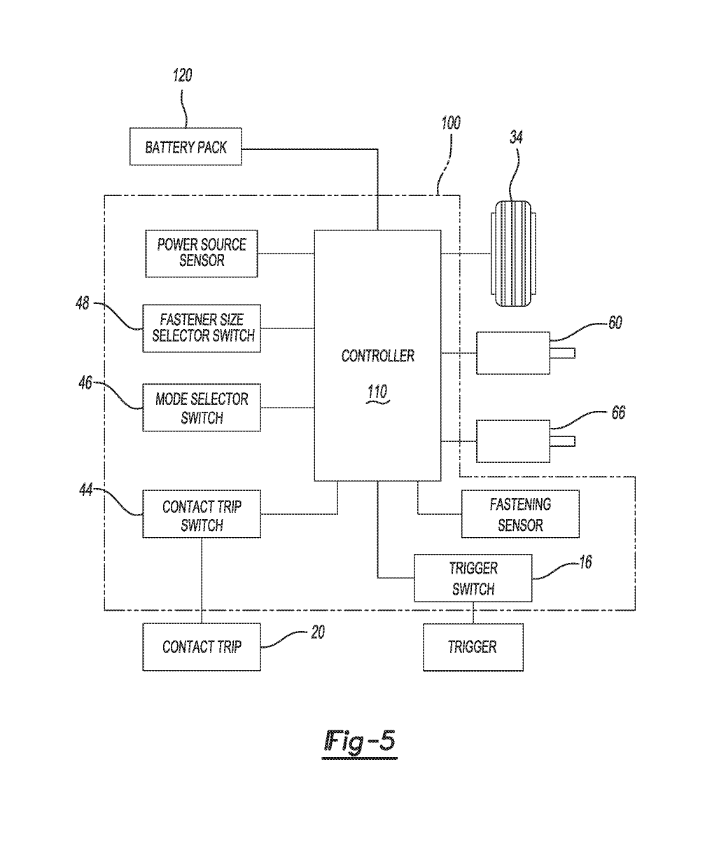

With additional reference to FIG. 5, the control circuit 100 includes a microcontroller 110 that is electrically connected to receive input signals from a plurality of switches/sensors, including the trigger switch 16, a contact trip switch 44, a mode selector switch 46 and a fastener size selector switch 48. The trigger switch 16 is an ON/OFF switch that controls the application of power from the battery pack 120 to the control circuit 100, which in turn controls the application of power to the motor/flywheel assembly 34.

The nosepiece assembly 18 as noted includes a contact trip mechanism 20 that extends from the nosepiece assembly 18 and prevents the tool from inadvertently firing a fastener. In particular, the contact trip mechanism 20 includes a tubular extension 20a which, when pressed against a workpiece, retracts into the nosepiece assembly 18. Retraction of tubular extension 20a causes a corresponding upward movement of the spring-loaded contact trip mechanism 20 until a tab 20b on the mechanism actuates a pivotable lever 20c which in turn closes the contact trip switch 44 mounted on the control module 42. The controller 100 is programmed to prevent the firing of the tool if the contact trip switch 44 is not closed.

In the preferred embodiment, the mode selector switch 46 is a 2-position switch that enables the user to select between two operating modes. One mode of operation may be, for example, a sequential fire mode wherein the contact trip 20 must first be abutted against a workpiece (so that the contact trip switch 44 is closed) and thereafter the trigger switch 16 is actuated to generate a firing signal. Another mode of operation may be a mandatory bump feed mode wherein the trigger switch 16 is first actuated to generate a trigger signal and thereafter the contact trip extension 20a is abutted against a workpiece so that the contact trip switch 44 is closed to generate the firing signal.

The fastener size selector switch 48 in the preferred embodiment may also be a 2-position selector switch, which in a first position sets the drive force of the tool to a first output level appropriate for installing fasteners of a first size, and in a second position sets the drive force of the tool at a second output level greater than the first output level appropriate for installing fasteners of a second size larger than the first size. In the preferred embodiment, the drive force output level of the tool is controlled by the control circuit 100 by adjusting the target rotational speed of the flywheel 52. A control algorithm for controlling the speed of the flywheel is described in greater detail in U.S. Pat. No. 8,534,527, also assigned to the assignee of the present application, which disclosure is incorporated herein by reference.

Additionally, the controller 110 is further programmed to generate output signals that control the activation of a pair of solenoids. A first solenoid 60 is part of the power take-off assembly 38 described in greater detail below, which controls the initiation of the drive stroke, and hence, the firing of the tool. The second solenoid 66 is part of the driver retraction assembly 40 which serves to retract the driver and return it to its original starting position following the completion of a drive stroke. The detailed operation of the control circuit 100 as it pertains to particular features of the present disclosure will be described in greater detail below.

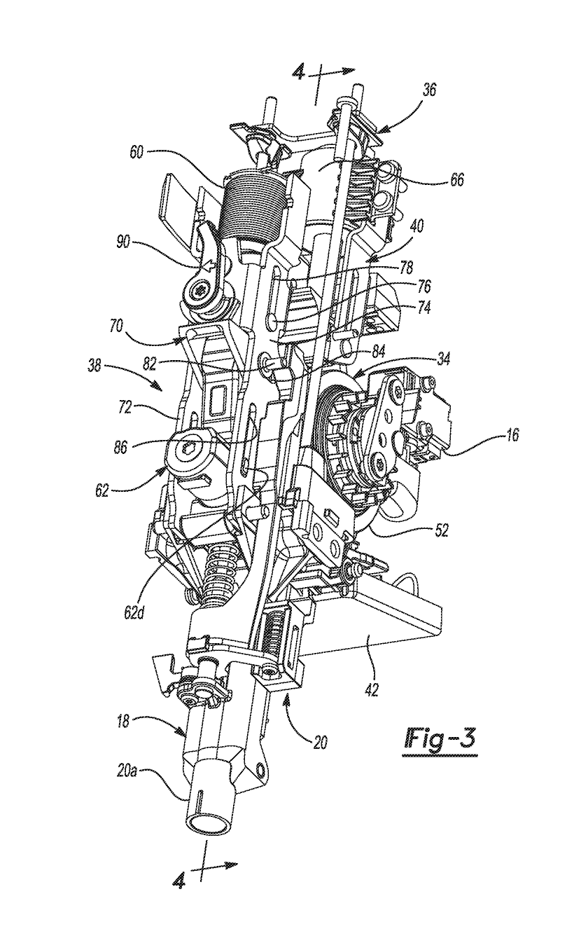

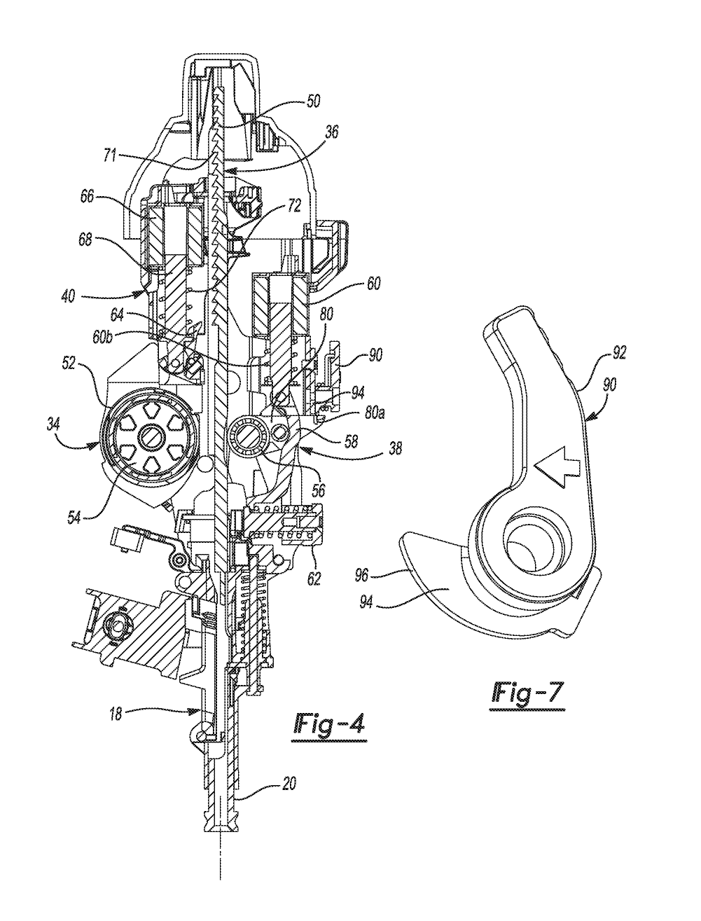

Turning to FIGS. 3 and 4, a portion of the present cordless concrete nailer 10 is shown with the frame member removed. The driver system 36 is located along the central axis of the tool and includes a driver 50 that is supported for oscillatory movement along said axis. In particular, the driver 50 is arranged to move rapidly in the downward direction, as depicted in the drawings, during the drive stroke, and to be retracted upward to its original position during the return stroke.

The driver 50 is driven by a flywheel 52, which in the preferred embodiment comprises the rotor of an outer rotor motor 54. The construction of a motor/flywheel assembly 34 of this type is described in greater detail in pending application Ser. No. 13/840,015, filed Mar. 15, 2013 and assigned to the assignee of the present application, which disclosure is incorporated herein by reference. The motor assembly 34 including the rotating outer flywheel 52 is mounted on one side of the driver 50, as shown in FIG. 4.

The driver 50 is selectively drivingly engaged with the flywheel 52 via operation of a power take-off (“PTO”) assembly 38 located on the opposite side of the driver 50, relative to the motor assembly 34. When actuated, the PTO assembly 38 is configured to move the driver 50 laterally relative to the axis of the tool 10, to thereby selectively engage, press or squeeze the driver 50 against the outer circumference of the flywheel 52. In general, the PTO assembly 38 includes a pinch roller 56, a linkage member or arm 58, a solenoid 60 and a compression spring assembly 62. Actuation of the PTO assembly 38 is achieved by energizing the solenoid 60 via a control signal from the control circuit 100. When energized, the solenoid 60 retracts the linkage arm 58, causing the pinch roller 56 to move laterally and engage the driver 50. The compression spring assembly 62 serves to apply a predetermined compression force on the pinch roller to insure that the driver 50 is tightly “pinched” against the outer circumferential surface of the flywheel 52. This action facilitates the efficient transfer of stored energy from the rotating flywheel 52 to the driver 50.

Also located on the motor assembly 34 side of the driver 50 is the driver retraction assembly 40. The driver retraction assembly 40 is configured to retract or return the driver 50 to its original “home” position, as illustrated in FIG. 4, following the execution of a drive stroke. In general, the driver retraction assembly 40 includes a pivoting latch member 64 that is coupled to and operated by a second solenoid 66. More specifically, when the solenoid 66 is energized by a control signal from the control circuit 100, the solenoid plunger 68 is retracted, thereby causing the latch member 64 to pivot clockwise and engage the ratchet teeth 71 formed on the confronting side of the driver 50. As the solenoid plunger 68 continues to retract, the driver 50 is incrementally raised or retracted a predetermined distance. When the solenoid 66 is de-energized, a return spring 72 causes the solenoid plunger 68 to return to its original extended position, as shown in FIG. 4, which similarly causes the latch member 64 to pivot counterclockwise and disengage from the driver 50. This cycle is repeated a predetermined number of times (e.g., 5) under the control of the control circuit 100, to insure that the driver 50 is fully retracted into its original home position before a succeeding drive stroke is initiated.

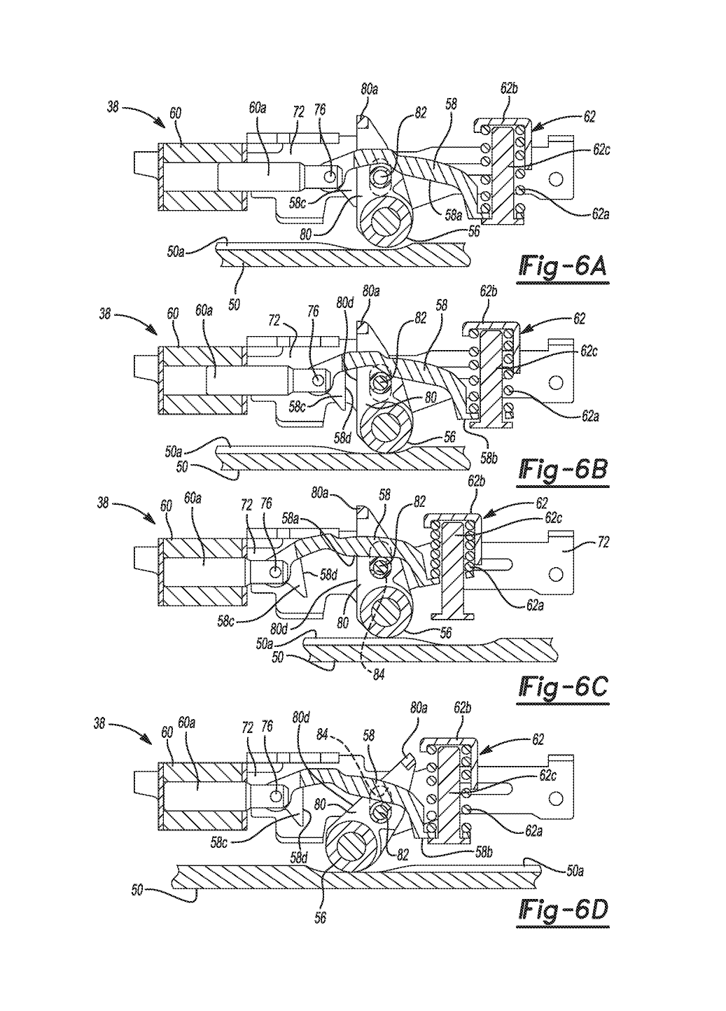

Turning now to FIGS. 6A-6D, a detailed description of the construction and operation of the PTO assembly 38 will now be explained.

The power take-off (“PTO”) assembly 38, when activated, presses or pinches the driver 50 into engagement with the outer circumferential surface of the flywheel 52, thereby transferring the rotational energy stored in the flywheel 52 to the driver 50. With additional reference to FIG. 3, the PTO assembly 38 includes a longitudinal U-shaped bracket 70 having complimentary parallel arms 72, 74 supporting a solenoid 60 at one end and a compression spring assembly 62 at the opposite end. The plunger 60a of the solenoid 60 is connected via a first pin or coupling 76 to a first, or rearward end of a complimentary pair of arms of the linkage arm 58. The other or forward end of the linkage member 58 is connected to the compression spring assembly 62 and is biased by the compression spring 62a toward the nail driver 50. Thus, the linkage arm 58 is coupled between the plunger 60a of the solenoid 60 and the compression spring 62a. The coupling 76 couples plunger 60a directly to the linkage arm 58. Alternatively, the coupling can be an assembly, including an extending arm that is coupled at one end to the plunger 60a and at an opposite end to the linkage arm 58, thereby indirectly coupling the plunger 60a and the arm 58 together. In the illustrated example, the linkage arm 58 extends fully between the plunger 60a and the compression spring 62a of the spring assembly 62. The first coupling 76 that couples the solenoid plunger 60a to the linkage arm 58 also rides within a first longitudinal slot 78 formed in the arms of the bracket 70.

The pinch roller 56 is journaled to a cam member or carrier 80 that is pivotably supported between the bracket arms 72, 74 by a second pin 82 which rides within a second vertically oriented slot 84 formed in the bracket arms 72, 74. The second pin 82 also serves as a cam follower and engages an inclined cam surface 58a formed on the underside of the linkage arm 58.

The compression spring assembly 62 comprises a high compression force spring 62a that is mounted within a cage 62b containing a vertically oriented post 62c supporting the spring 62a. The compression spring 62a is contained between the top of the cage 62b at its upper end and the forward end 58b of the linkage arm 58 at its lower end. The cage 62b of the compression spring assembly 62 is provided with a third flat-sided pin 62d that rides within a third horizontally disposed slot 86 formed in the arms 72, 74 of the bracket 70. Thus, the compression spring assembly 62 is able to move horizontally fore and aft with the movement of the solenoid plunger 60a.

With particular reference to FIGS. 6A-6D, the PTO assembly operates in the following manner. Before the onset of the drive stroke, the plunger 60a of the solenoid 60 is fully extended, and the carrier 80 and pinch roller 56 are in their uppermost position. In addition, the linkage arm 58 and compression spring assembly 62 are in the positions shown in FIG. 6A. With the PTO assembly 38 in this condition, the driver 50 is disengaged from the flywheel 52. In the positions of FIG. 6A, the linkage arm 58 includes or carries a protrusion 58c that has a front or forward facing edge or surface 58d engaging against a rear or rearward facing edge or surface 80d of the carrier 80 to orient the carrier 80 in an corresponding engagement orientation or position.

In the illustrated example, the corresponding engagement orientation of the carrier 80 is at or near an overcenter orientation or position. In such an overcenter orientation or position, the axis of cam follower or pivot pin 82 extending through the carrier 80 is in a leftward or rearward position relative to the axis of pinch roller 56 carried by the carrier 80. Without insuring an appropriate initial orientation or position of the carrier 80, the carrier 80 might be oriented in an improper position, such as that illustrated in FIG. 6D, causing the tool to misfire when activated. In this example, the corresponding engagement orientation of the carrier 80 is limited to a single rotational or angular orientation of the carrier 80. Also in this example, engagement surface 58d and the cooperating engagement surface 80d each comprise a linear surface, and these linear surfaces 58d, 80d are in face-to-face contact in the engagement position. In other examples, the corresponding engagement orientation of the carrier 80 can include a range of acceptable orientations.

To initiate the drive stroke, the PTO solenoid 60 is energized and the plunger 60a of the solenoid is retracted, thereby pulling the linkage arm 58 from right (forward) to left (rearward) as shown in the drawings. Referring to FIG. 6B, as the plunger 60a and the linkage arm 58 begins moving to the left, the protrusion 58c and its engaging surface 58d moves rearward away from the cooperating engaging surface 80d of the carrier 80 while the carrier 80 is forced downward at or near its corresponding engagement orientation by the interaction between the second cam follower pin 82 and the inclined cam surface 58a on the underside of the arms of the linkage member 58. This vertical movement of the carrier 80 causes the properly oriented pinch roller 56 to press the driver 50 into engagement with the outer circumferential surface of the flywheel 52, thereby initiating the drive stroke of the driver 50, as shown in FIG. 6B. Once the drive stroke is initiated, the pinch roller 56 “rides up” onto the raised drive surface 50a formed on the opposing surface of the driver 50, thereby causing the forward end 58b of the linkage arm 58 to compress the compression spring 62a. Hence, with the solenoid 60 in its fully retracted position illustrated in FIG. 6C and the compression spring 62a compressed, the pinch roller 56 exerts a compression force of preferably at least about 500 pounds per square inch (or about 345 Newtons per square centimeter) against the driver 50 and, between the driver 50 and the flywheel 52, insuring the efficient transfer of energy from the flywheel 52 to the driver 50. The release of the compressive force at the end of the driver 50 stroke imparts a pivot force on the carrier 80 that has a magnitude that is related to a magnitude of the compressive force. As illustrated in FIG. 6D, the engaging surface 58d is in the disengagement position when the compressive force is released.

The engaging surface 58d is movable with the plunger 60a from its an engagement position in which the engaging surface 58d engages the cooperating engaging surface 80d of the carrier 80 and orients the carrier 80 into the corresponding engagement orientation (FIG. 6A). As seen in FIG. 6A, the engagement position corresponds to an extended position of the plunger 60a. The engaging surface 58d is also movable with the plunger 60a into a disengagement position in which the engaging surface 80d is spaced away from the cooperating engaging surface 80d of the carrier 80 allowing the carrier 80 to pivot outside the corresponding engagement orientation (FIGS. 6B-6D). As seen in FIGS. 6B-6D, the disengagement position corresponds to a retracted position of the plunger 60a. In the illustrated example, the engagement surface is positioned adjacent the coupling 76 between the plunger 60a and the linkage arm 58.

At the end of the drive stroke, the end of the raised drive surface 50a on the driver 50 passes the pinch roller 56, as shown in FIG. 6D. As the pinch roller 56 rides down the trailing end of the raised drive surface 50a, the angle of the trailing end causes the carrier 80 to pivot clockwise and release the overcenter configuration of the carrier 80 (i.e., the axis of cam follower pin 82 is in a rightward or forward position relative to the axis of pinch roller 56), as shown in FIG. 6D, and thereby releases the compression force on the pinch roller 56 applied by the compression spring 62a. The carrier 80 is able to move into this release or reverse overcenter configuration, position, or orientation because the solenoid 60 has moved the engaging surface 58d of the protrusion 58c sufficiently rearward, or away from the cooperating engaging surface 80d of the carrier 80. With the PTO assembly 38 in this position, the driver 50 is effectively disengaged from the flywheel 52.

After a predetermined time period sufficient to insure completion of the drive stroke, the power to the solenoid 60 is interrupted. Once the solenoid 60 is de-energized, a return spring 60b (FIG. 4) on the solenoid 60 drives the plunger 60a outward (i.e., to the right in FIGS. 6A-6D) into its original position, returning the linkage arm 58 to its original position. As the linkage arm 58 returns to its original or initial position (FIG. 6A), the engaging surface 58d of the protrusion 58c moves back forward toward and into engagement with the cooperating engaging surface 80d of the carrier 80, causing the carrier 80 to also rotate or pivot counterclockwise into its initial position shown in FIG. 6A. Thus, with the PTO assembly 38 returned to its fully disengaged position, the driver 50 is free to be retracted by the return mechanism 40 into its “home” position in preparation for the next firing stroke.

On occasion, due to various external factors such as obstructions in the workpiece, a fastener may fail to become fully installed in the workpiece, and thereby prevent the driver 50 from completing the drive stroke. In such an event, the driver stroke may be interrupted with the carrier 80 in its overcenter configuration while the pinch roller 56 is still engaged with the raised drive surface 50a and the driver 50. Under such circumstances, the driver 50 may become “jammed” with the retraction mechanism 40 unable to retract the driver 50 despite the PTO solenoid 60 being de-energized.

To address this contingency and completely release the pressure applied by the PTO assembly 38 on the driver 50, the PTO assembly 38 is further provided with a release lever 90 that is rotatably mounted to the top of the U-shaped bracket 70. With reference to FIG. 7, the release lever 90 comprises a lever arm 92 and an arcuate cam portion 94 having an eccentric outer cam surface 96. When installed on the U-shaped bracket 70, the lever portion 92 of the release lever 90 is exposed on the outer surface of the housing 12 (FIG. 1), and the cam portion 94 of the release lever 90 is positioned adjacent to a raised tab 80a formed on the carrier 80, as best shown in FIG. 4. When the release lever 90 is rotated, the eccentric outer cam surface 96 of the cam portion 94 acts on the raised tab 80a causing the carrier 80 to rotate clockwise from the overcenter configuration or position shown in FIG. 6C to the released or reverse-overcenter configuration or position shown in FIG. 6D. With the carrier 80 in the position shown in FIG. 6D, the pressure applied by the pinch roller 56 on the driver 50 is relieved, thereby freeing the driver 50 and enabling the retraction mechanism 40 to retract the driver 50 to its initial home position. A similar stall release lever is disclosed in commonly assigned U.S. Pat. No. 9,399,281, filed Mar. 12, 2013 and issued Jul. 26, 2016, the entirety of which is incorporated herein by reference.

The foregoing description of an example embodiment has been provided for purposes of illustration and description. It is not intended to be exhaustive or to limit the disclosure. Individual elements or features of a particular embodiment are generally not limited to that particular embodiment, but, where applicable, are interchangeable and can be used in a different embodiment, even if not specifically shown or described. The same may also be varied in many ways. Such variations are not to be regarded as a departure from the disclosure, and all such modifications are intended to be included within the scope of the disclosure.

What is claimed is:

1. A cordless electric nailer comprising:
a power take-off (PTO) assembly positioned to selectively engage a nail driver against a battery-powered electric motor driven flywheel, the PTO including:
a bracket supporting a solenoid and a compression spring;
a linkage arm coupled between a plunger of the solenoid and the compression spring, and the linkage arm being biased by the compression spring toward the nail driver;
a carrier supporting a pinch roller and the carrier being pivotably mounted to the bracket via a pivot pin;
an engaging surface movable with the plunger between an engagement position in which the engaging surface engages a cooperating engaging surface of the carrier and orients the carrier into a corresponding engagement orientation, and a disengagement position in which the engaging surface is spaced away from the cooperating engaging surface of the carrier allowing the carrier to pivot outside the corresponding engagement orientation.

2. The cordless electric nailer of claim 1, wherein the corresponding engagement orientation is limited to a single orientation of the carrier.

3. The cordless electric nailer of claim 2, wherein the engagement and cooperating engagement surfaces each comprise a linear surface, and the linear surfaces are in face-to-face contact in the engagement position.

4. The cordless electric nailer of claim 1, wherein the corresponding engagement orientation includes an orientation of the carrier in which the carrier is in or near an overcenter position with respect to an axis of the pivot pin and an axis of the pinch roller.

5. The cordless electric nailer of claim 1, wherein the engagement surface is positioned adjacent a coupling between the plunger and the linkage arm.

6. The cordless electric nailer of claim 5, wherein the coupling directly couples the plunger to the linkage arm.

7. The cordless electric nailer of claim 1, wherein a surface of a protrusion comprises the engagement surface.

8. The cordless electric nailer of claim 1, wherein a surface of the linkage arm comprises the engagement surface.

9. The cordless electric nailer of claim 1, wherein a surface of a protrusion of the linkage arm comprises the engagement surface.

10. The cordless electric nailer of claim 1, wherein the engagement position corresponds to an extended position of the plunger.

11. The cordless electric nailer of claim 12, wherein the disengagement position corresponds to a retracted position of the plunger.

12. The cordless electric nailer of claim 1, wherein the cordless electric nailer is a concrete nailer.

13. The cordless electric nailer of claim 12, wherein the spring of the concrete nailer provides a biasing force on the linkage arm that generates a compressive force on the nail driver through the pinch roller, and release of the compressive force imparts a pivot force on the carrier having a magnitude that is related to a magnitude of the compressive force.

14. The cordless electric nailer of claim 13, wherein the engaging surface is in the disengagement position when the compressive force is released.

15. The cordless electric nailer of claim 13, wherein a magnitude of the compressive force is at least about 500 pounds per square inch.

16. The cordless electric nailer of claim 1, wherein the linkage arm extends fully between the plunger and the compression spring.

17. The cordless electric nailer of claim 1, wherein the pivot pin is a cam follower pin and is supported in slots of the bracket, and the linkage arm comprises a cam surface that the cam follower pin follows.

18. A cordless electric concrete nailer comprising:
a power take-off (PTO) assembly positioned to selectively engage a concrete nail driver against a battery-powered electric motor driven flywheel, the PTO including:
a bracket supporting a solenoid and a compression spring;
a linkage arm coupled between a plunger of the solenoid and the compression spring, and the linkage arm being biased by the compression spring toward the concrete nail driver;
a carrier supporting a pinch roller and the carrier being pivotably mounted to the bracket via a pivot pin;
an engaging surface movable with the plunger between an engagement position in which the engaging surface engages a cooperating engaging surface of the carrier and orients the carrier into a corresponding engagement orientation, and a disengagement position in which the engaging surface is spaced away from the cooperating engaging surface of the carrier allowing the carrier to pivot outside the corresponding engagement orientation, wherein the spring of the concrete nailer provides a biasing force on the linkage arm that generates a compressive force of at least about 500 pounds per square inch on the concrete nail driver through the pinch roller.

19. The cordless electric concrete nailer of claim 18, wherein a surface of the linkage arm comprises the engagement surface.

20. The cordless electric nailer of claim 19, wherein a surface of a protrusion of the linkage arm comprises the engagement surface.
